(19) United States
(12) Patent Application Publication
(10) Pub. No.: US 2024/0286079 A1
(43) Pub. Date: Aug. 29, 2024

(54) MEMBRANE FILTER SYSTEM AND METHOD FOR MEMBRANE FILTERING A LIQUID

(71) Applicant: B. Braun Avitum AG, Melsungen (DE)

(72) Inventors: Nino Lieb, Melsungen (DE); Philipp Odernheimer, Melsungen (DE); Jonas Giesa, Kassel (DE); Stephan Krietemeyer, Kandern (DE)

(21) Appl. No.: 18/582,851

(22) Filed: Feb. 21, 2024

(30) Foreign Application Priority Data
Feb. 23, 2023 (DE) 10 2023 104 502.4

(51) Int. Cl. B01D 61/02; B01D 61/10; B01D 61/12

(52) U.S. Cl. CPC B01D 61/025; B01D 61/10; B01D 61/12

(57) ABSTRACT

A membrane filter system, in particular for reverse osmosis, includes a storage tank, a ring line for connecting consumers, and at least one stage that includes a membrane module connected to a concentrate line for delivering a concentrate volume flow and a permeate line for delivering a permeate volume flow, a feed line to the membrane module, at least one booster pump for pumping liquid into the membrane module, and at least one circulation pump for returning concentrate from the membrane module to the feed line. At least two sensors measure process variables. A respective sensor is connected to at least one control and regulation unit on a signal input side. The at least one control and regulation unit regulates the pumps based on the sensor signals of the at least two sensors.

### CROSS-REFERENCE TO RELATED APPLICATION

This application claims priority under 35 U.S.C. § 119 to German Application No. 2023 104 502.4, filed on Feb. 23, 2023, the content of which is incorporated by reference herein in its entirety.

### FIELD

The present disclosure relates to a membrane filter system and a method for membrane filtering of a liquid.

### BACKGROUND

Membrane filter systems are used according to the principle of reverse osmosis to filter out salts and other substances from a liquid during dialysis. During dialysis treatment, patients come into contact with a large amount of dialysate, which consists of almost 99.3% water.

The dialysis fluid and the patient's blood are only separated by a semi-permeable membrane. Clinical studies show that contamination in the dialysis water contributes to acute and chronic problems and can lead to severe complications in hemodialysis patients. Water quality is therefore a key factor in modern dialysis. As water is extremely important for patients, there is simply no substitute for the highest possible water purity during dialysis.

U.S. Pat. No. 6,797,173 B1 discloses a device and a process suitable for a reverse osmosis system. A process chamber with an inlet, a low-pressure outlet and a high-pressure outlet is provided. A feed pump is used to increase the feed pressure to the process chamber.

The disadvantage of known membrane filter systems is that they are operated without taking the current consumption situation into account.

### SUMMARY

The present disclosure is therefore based on the object of improving a membrane filter system described above in such a way that it can be operated in an energy-saving manner. Furthermore, an advantageous process for membrane filtration of a liquid, suitable for reverse osmosis, is to be disclosed.

The present disclosure is based on the consideration that an energy-saving operation of a membrane filter system would be advantageous. Since the number and consumption quantity of the consumers connected to the system changes over time, an unadjusted operation of the liquid delivery is not economical. However, energy-saving operation would have to take into account the current consumer situation at the membrane filter system.

As has now been recognized, this goal can be achieved by using at least one process variable to control at least one pump of the membrane filter system. Depending on whether or how many consumers are connected to the ring line, process variables such as pressure or flow rate change. These process variables can therefore be used to determine the current consumption of the system and adapt the delivery of liquid through the ring line accordingly.

The expression that the control and regulation unit is configured to regulate the pumps on the basis of the sensor signals from the at least two sensors means in particular that the control and regulation unit is adapted or designed or programmed or set up to perform the regulation. The corresponding regulation is preferably implemented in hardware and/or software in the control and regulation unit. Accordingly, the control and regulation unit carries out this regulation based on the sensor signals. The same applies to the configuration of the control and regulation unit in preferred embodiments of the present disclosure.

In particular, the present disclosure comprises the control of all pumps in the respective stage, i.e., both the respective booster pump and the respective circulation pump of a stage.

Controlling a pump preferably involves controlling the speed of the pump. Preferably, the speed of the pump is set during control in such a way that an actual value is adjusted to a setpoint value. The setpoint and actual values preferably relate to a pressure in a line or a flow rate through a line.

The pumps are preferably designed as centrifugal pumps with a frequency converter. The frequency converter can be integrated into the pumps or connected to the pumps via the power supply line.

The control and regulation unit is advantageously configured in such a way that it adapts a permeate volume flow and a concentrate volume flow to the current consumer withdrawal by regulating the booster pump and the circulation pump.

The respective sensor is advantageously designed as a pressure sensor or a flow sensor.

In a preferred embodiment, the at least one sensor is a pressure sensor. A pressure sensor is particularly suitable for detecting the utilization of the system by connected consumers. Controlling the system according to a pressure setpoint and adjusting the speed of the corresponding booster pump can contribute in particular to an energy-efficient operation of the system. Control via the process pressure means that exact knowledge of the number and actual consumption of consumers is not necessary.

The pressure sensor advantageously measures the pressure at one end of the ring line on the supply tank, which is located downstream of the consumers, i.e., at the tank inlet, so to speak. A pressure measurement at this point provides a particularly precise indication of the withdrawal from the liquid system. The pressure sensor is preferably located at this end of the ring line. A pressure measurement at this point records all connected consumers or the pressure loss caused by the consumers.

In a preferred embodiment, at least one pressure sensor is provided, wherein the at least one control and regulation unit is configured to increase the speed of the booster pump when the measured pressure falls below a pressure setpoint value by the pressure sensor in such a way that the pressure setpoint value is reached by the actual pressure value, and to reduce the speed of the booster pump when the measured pressure exceeds the pressure setpoint value in such a way that the pressure setpoint value is reached by the actual pressure value. The controls for a flow rate setpoint are also to be understood as equivalent.

In a preferred embodiment, the membrane filter system comprises a flow sensor arranged at the beginning of the ring line for measuring the liquid flow leaving the membrane module on the permeate side and a flow sensor for measuring the liquid flow leaving the membrane module on the concentrate side, wherein the control and regulation unit is configured to control the speed of the circulation pump as a function of the flow rate measured by the flow sensors, the design of the membrane module and the overflow factor in such a way that a desired flow rate setpoint value is realized in the concentrate.

“Overflow” or “overflow factor” refers to the ratio of product to reactant or indicates a ratio of process water supplied to permeate produced, taking into account the number of membranes.

The design of the membrane module is understood here to mean in particular the number and/or size of the membrane elements and/or their arrangement in rows or in parallel and/or their permeability or filter properties, or combinations thereof. In particular, the number of membrane elements is taken into account.

Advantageously, the membrane filter system comprises an attenuator, in particular arranged in the ring line. Advantageously, the attenuator is arranged in the area of the end of the ring line at the feed tank.

This positioning has a minimal effect on the controlled system, as the rapid pressure reduction at the end of the controlled system only introduces minimal additional system dynamics.

Preferably, the damping element comprises an overflow valve that opens as soon as the pressure applied to the overflow valve is greater than the set holding pressure. As soon as the pressure applied to the overflow valve is greater than the set holding pressure, this valve opens successively to allow the pressure to escape into the receiver tank. In this way, pressure peaks can be intercepted. The overflow valve is preferably designed as a purely mechanical valve.

In a preferred design, the attenuator comprises an overflow valve and a flow limiter. In this variant, the overflow valve fulfils a dual function. In addition to intercepting pressure peaks, it also acts as a bypass, which is used for chemical and thermal disinfection, for example.

This design ensures that a defined minimum volume flows through the ring line at all times, as the flow limiter operates independently of pressure. The overflow valve is closed during regular operation and is only present to intercept pressure peaks and bypass higher volume flows. The pressure can be used as a control variable in this configuration. The advantage of this is that the consumers and the connected ring main can be controlled as a disturbance variable without having to have extensive knowledge of the system.

The attenuator advantageously comprises a diaphragm expansion vessel or a solenoid valve in conjunction with a pressure switch or pressure sensor.

Preferably, this achieves the minimum defined volume so that there is no standing water inside the system or installation.

The membrane module advantageously comprises a number of sub-membrane modules connected in series or in parallel, whereby the respective sub-membrane module comprises a number of membranes. It filters substances from the liquid that are fed into the membrane module and has two separate areas, namely a permeate area and a concentrate area. The permeate is the purified water. Recirculation can reduce water consumption as water is reused.

The at least one control and regulation unit can be realized in hardware and/or software. A separate control and regulation unit can be provided for each pump and/or each control process. Communication can be either analogue, via bus systems or by manipulating voltage levels (0 and 1). The control and regulation units can be combined in a plurality or in a single control and regulation unit.

In a preferred embodiment of the membrane filter system, a flow sensor is arranged downstream of the feed tank and downstream of the at least one consumer connection and/or at least one flow sensor is arranged between the ring line and at least one consumer connection, which is connected on the signal input side to the at least one control and regulation unit, which regulates the booster pump according to a flow setpoint value. A pressure measurement at this point provides a particularly precise indication of the utilization of the system. The pressure sensor is preferably located at this end of the ring line. A pressure measurement at this point records all connected consumers or the pressure loss caused by the consumers.

The membrane filter system described above with a booster pump, a membrane module and a circulation pump in a preferred embodiment has a single-stage design, i.e. it comprises exactly one stage or filter stage.

The present disclosure also includes multi-stage membrane filter systems, each of the stages comprising a booster pump, a circulation pump and a membrane module. In multi-stage systems, each further stage preferably hydraulically connects to the respective previous stage downstream, so that a sequence of stages is formed. In particular, this means that the permeate flow from the previous stage is conveyed to the hydraulically adjacent stage.

In a first preferred embodiment, the membrane filter system comprises two stages, the first stage comprising a first membrane filter module, a first booster pump and a first circulation pump, the second stage, which is arranged downstream of the first membrane module, comprising a second membrane module, a second booster pump downstream of the first membrane module and a second circulation pump, wherein a first pressure sensor is arranged on the suction side of the second booster pump, and wherein the at least one control and regulating unit is configured to perform a pressure setpoint control of the first booster pump on the basis of the pressure value measured by the first pressure sensor, and wherein a second pressure sensor is arranged downstream of the second diaphragm module, and wherein the at least one control and regulating unit is configured to perform a pressure setpoint control of the second booster pump on the basis of the pressure value measured by the second pressure sensor.

Flow sensors can also be used instead of pressure sensors. The corresponding circulation pump is preferably controlled in the same way as described above for the single-stage membrane filter system.

In a further preferred embodiment, the membrane filter system comprises two stages, the first stage comprising a first membrane filter module, a first booster pump and a first circulation pump, the second stage, which is arranged downstream of the first membrane module, comprising a second membrane module, a second booster pump downstream of the first membrane module and a second circulation pump, wherein a first pressure sensor is arranged at the end in the ring line upstream of the feed tank, and wherein the at least one control and regulation unit is configured to perform a pressure setpoint control of the first booster pump based on the pressure value measured by the first pressure sensor, and wherein a second pressure sensor is arranged permeably in the ring line upstream of the feed tank, and wherein the at least one control and regulating unit is configured to perform a pressure setpoint control of the first booster pump on the basis of the pressure value measured by the first pressure sensor, and wherein a second pressure sensor is arranged on the permeate side downstream of the first diaphragm module, and wherein the at least one control and regulating unit is configured to perform a pressure setpoint control of the second booster pump on the basis of the pressure value measured by the second pressure sensor.

Flow sensors can also be used instead of pressure sensors. The corresponding circulation pump is preferably controlled in the same way as described above for the single-stage membrane filter system.

Advantageously, the membrane module of the respective stage comprises a number of sub-membrane modules connected in series or in parallel, wherein the respective sub-membrane module comprises a number of membranes.

With regard to the method, the above-mentioned object is solved according to the present disclosure.

The at least one process variable is preferably the pressure and/or the liquid flow rate at one point of the ring line.

The present disclosure also relates to a membrane filter system, in particular for reverse osmosis, comprising a storage tank, a ring line for connecting consumers, and at least one stage or filter stage, which comprises:
a membrane module connected to a concentrate line for delivering a concentrate volume flow and a permeate line for delivering a permeate volume flow;
a feed line to the membrane module;
at least one booster pump for pumping liquid into the membrane module;
at least one circulation pump for returning concentrate from the membrane module to the feed line,
   wherein at least two sensors are provided for the respective measurement of a process variable, and wherein at least one control and regulating unit is provided, and wherein the respective sensor is connected on the signal input side to the at least one control and regulating unit, and wherein the at least one control and regulating unit is configured to regulate the pumps on the basis of the sensor signals of the two sensors, and wherein the membrane filter system has an attenuator, in particular arranged in the ring line.

Advantageously, the attenuator is arranged upstream of the receiver tank, in particular directly upstream. This positioning has a minimal effect on the controlled system, as the rapid pressure reduction at the end of the controlled system only introduces minimal additional system dynamics.

Preferably, the damping element comprises an overflow valve that opens as soon as the pressure applied to the overflow valve is greater than the set holding pressure. As soon as the pressure applied to the overflow valve is greater than the set holding pressure, this valve opens successively to allow the pressure to escape into the receiver tank. In this way, pressure peaks can be intercepted. The overflow valve is preferably designed as a purely mechanical valve.

In a preferred design, the attenuator comprises an overflow valve and a flow limiter. In this variant, the overflow valve fulfils a dual function. In addition to intercepting pressure peaks, it also acts as a bypass, which is used for chemical and thermal disinfection, for example. This design ensures that a defined minimum volume flows through the ring line at all times, as the flow limiter acts independently of pressure. The overflow valve is closed during regular operation and is only present to intercept pressure peaks and bypass higher volume flows. The pressure can be used as a control variable in this configuration. The advantage of this is that the consumers and the connected ring main can be controlled as a disturbance variable without having to have extensive knowledge of the system.

The attenuator advantageously comprises a diaphragm expansion vessel or a solenoid valve and a pressure switch or pressure sensor. Advantageously, the attenuator comprises a solenoid valve and a pressure switch.

The advantages of the present disclosure lie in particular in the fact that the sensors for measuring process variables allow the membrane filter system to be operated as required and thus in an energy-saving manner, as the speed can be reduced during a lower consumption period. The fact that the pumps involved can be operated at a lower speed when consumption is low means that the noise generated by the system can be reduced and unnecessary heat generation can be avoided.

### BRIEF DESCRIPTION OF THE DRAWINGS

An embodiment of the present disclosure is explained in more detail with the aid of a drawing. This drawing in a highly schematized representation shows in:

FIG. 1 components of a membrane filter system according to the state of the art;

FIG. 2 a membrane filter system in a first preferred embodiment;

FIG. 3 a two-stage membrane filter system in a preferred embodiment;

FIG. 4 a single-stage membrane filter system in a preferred embodiment, and

FIG. 5 a two-stage membrane filter system in a further preferred embodiment.

### DETAILED DESCRIPTION

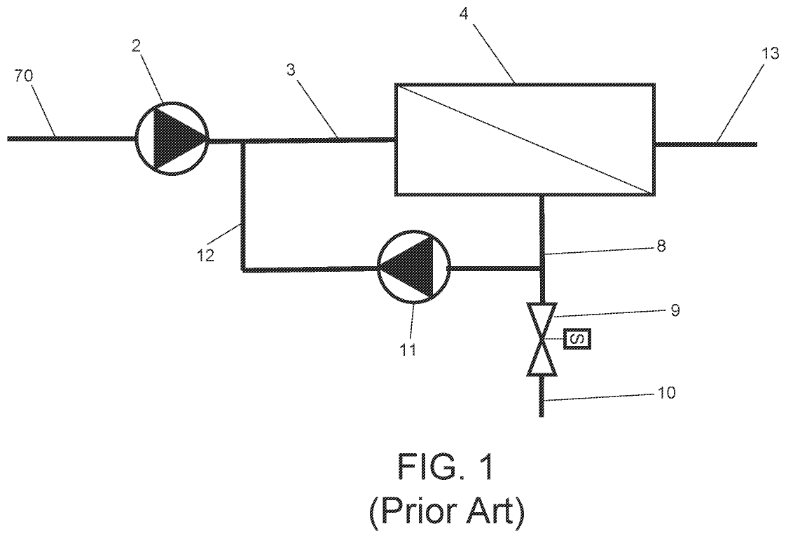

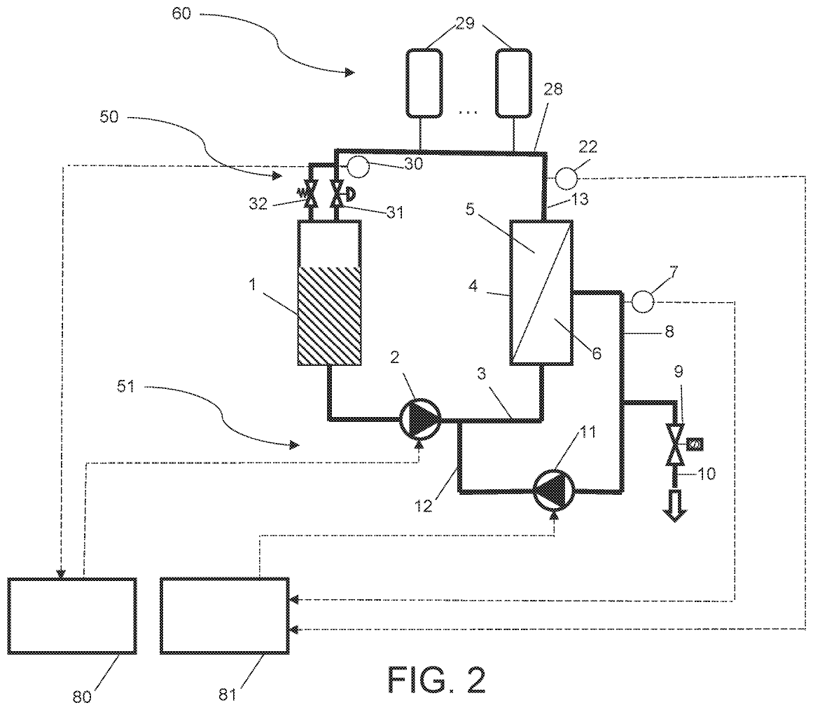

FIG. 1 schematically shows components of a membrane filter system 60 from the prior art. Such a membrane filter system is shown, for example, in U.S. Pat. No. 6,797,173 B1 in FIG. 2.

The general hydraulic design of a membrane filter system 60 shown in FIG. 1 has been known for several decades. A feed flow 70 is pressed into a membrane module 4 via a booster pump 2. The membrane module 4 can contain one or more membranes, each of which is connected in groups in series or in parallel. Furthermore, several membrane modules 4 can be connected in series with one another.

The process produces a filtered permeate flow from the membrane module 4 in a permeate line 13 and a concentrate flow in a concentrate line 8, which removes the retained substances. A circulation pump 11 conveys part of the concentrate, i.e., the recirculated concentrate 12, in the concentrate flow back to the booster pump 2, where it mixes with the feed flow 70 and repeats the process as feed water. The unrecirculated portion of the concentrate is discharged from the system as waste water via a valve 9 (e.g. a solenoid valve, needle valve, electric control valve, etc.). This system always produces an approximately equal volume of permeate, which, however, is independent of the actual utilization. This means that the energy consumption remains at a constant level.

A known modification of the known system is the use of a variable-speed pump as a booster pump 2 or a variable-speed pump as a circulation pump 11. This enables adaptive adjustment of the production pressure or the overflow, but not both within one system. This significantly limits the potential energy savings, as both the permeate volume flow and the concentrate volume flow are implicitly dependent on each other due to the overflow.

An improved membrane filter system 60 according to the present disclosure in a preferred embodiment is shown in FIG. 2. The membrane filter system 60 comprises a storage tank 1. A pressure sensor 30 is arranged at the tank inlet of the feed tank. The membrane filter system 60 comprises exactly one stage or filter stage 51 with a membrane module 4, in which permeate 5 is separated from feed water, the concentrate 6 being the by-product of this separation process.

The water from the storage tank 1 is fed into the membrane module 4 through a feed line 3 by means of a booster pump 2 together with the recirculated concentrate 12. The permeate 5 is fed into the ring line 28 and the concentrate 6 is fed into the concentrate line 8. The membrane filter system 60 further comprises a circulation pump 11. It further comprises a flow sensor 22 for measuring the permeate volume flow and a flow sensor 7 for measuring the concentrate volume flow. The membrane filter system 60 comprises a first control and regulating unit 80 and a second control and regulating unit 81.

The membrane filter system 60 comprises a self-regulating flow limiter 31 and an overflow valve 32 connected hydraulically in parallel, which together form an attenuator 50. The self-regulating flow limiter 31 allows a defined volume of liquid (independent of the pressure) to flow back into the storage tank 1. At a defined threshold value, the overflow valve 32 opens and lets water back into the storage tank 1. The overflow valve 32 is preferably designed as a purely mechanical component. A spring is used to set the opening pressure. When the pressure threshold value is exceeded, the spring force is overcome and the overflow valve opens. The higher the pressure, the more the spring yields and the more fluid can flow through the overflow valve. When the pressure falls below the pressure threshold value, the overflow valve closes accordingly.

A ring line 28 hydraulically connects the permeate line 13 (including flow sensor 22) with the attenuator 50 and pressure sensor 30. One or more consumers 29 can be connected to the ring line 28.

The pressure pump or booster pump 2 or the control and regulation unit 80 uses the pressure at the end of the ring line 28 as the process variable, which is measured by the pressure sensor 30, which is connected to the control and regulation unit 80 on the signal input side. As soon as at least one consumer 29 draws permeate from the system, this causes a drop in pressure. The booster pump 2 reacts to this negative deviation from the setpoint value by increasing its pump speed via the control and regulation unit 80 and thus correspondingly increasing the permeate volume flow. If a consumer 29 is omitted, the overproduced permeate would lead to an increase in pressure, as the flow limiter 31 only allows the defined volume flow to pass. The positive deviation from the setpoint leads to a reduction in the speed of the booster pump 2.

The flow sensor 7 and the flow sensor 22 are connected on the input side to the second control and regulation unit 81, which regulates the circulation pump 11. The speed control of the circulation pump 11 is implicitly linked to the control of the booster pump 2 and thus to the permeate volume of the consumer 29. The increasing or decreasing permeate flow is detected by the flow sensor 22. As a result, the overflow is adjusted accordingly by increasing or decreasing the concentrate volume flow via the speed of the circulation pump 11. The flow sensor 22 and the flow sensor 7 or their signals are therefore used as process variables.

Waste water 10, which is discharged from the system via a valve 9, in particular a solenoid valve, is also included in the calculation, as the volume also flows via the flow sensor 7 and therefore contributes to the overflow. This allows the speed of the circulation pump 11 to be reduced when valve 9 is open or partially open.

In a preferred embodiment, the valve 9 is designed as a solenoid valve. In an advantageous embodiment, the valve 9 is designed as an electrical or mechanical control valve

The two control and regulation units 80, 81 can also be designed as a single or integrated control and regulation unit, which then takes over the regulation functions for both pumps 2, 11. The regulation is integrated into the control and regulation unit 80, 81 in terms of software and/or hardware

Preferably, the speed is controlled by a frequency converter and the control value is calculated by a processor. The control value can either be calculated decentrally by the individual frequency inverters or centrally by an evaluation unit. A combination of centrally calculated control value 1 and decentrally calculated control value 2 to control value n is also possible.

Two control targets can be specified for the membrane filter system 60 shown. As a first control target, a fixed pressure can be required at the end of the ring line 28 so that there is always sufficient water. The pressure is measured by the pressure sensor 30. As a second control target, it is required that an overflow always occurs in order to prevent the membrane from blocking, which must occur depending on the number of membranes installed in the membrane module 4.

V_{concentrate}=(V Permeate/(number of membranes))*overflow. The letter “V” denotes the volume in each case. The concentrate is measured by the flow sensor 7, the permeate by the flow sensor 22. The concentrate volume thus results from the product of the quotient of the permeate volume and the number of membranes and the overflow or the overflow factor.

The overflow is therefore defined as

Overflow=(V_{concentrate}/V_{Permeate})*Σmembranes. The Greek letter “Σ” is the mathematical summation symbol. The overflow thus results from the quotient of concentrate volume and permeate volume, multiplied by the number of membranes.

The two control targets are controlled independently of each other, but are correlated in terms of the system/process. As described above, the consumption of permeate from the ring line increases the speed of the booster pump 2, which results in a higher permeate volume flow. Due to the increased permeate volume flow, the divisor of the above equation becomes larger, which leads to a reduction in the overflow. To compensate for this, the concentrate volume flow is adjusted accordingly by adjusting the speed of the circulation pump 11.

Possible controlled variables are the volume flow of the first stage 51 or the permeate of the first stage, whereby the measurements are carried out by the sensors and/or pressure, volume flow are measured or the concentrate of the first stage, whereby volume flows are measured by the sensors 22 and 7. The permeate pressure is measured for the control of booster pump 2 and the permeate volume flow and concentrate volume flow are measured for the control of circulation pump 11. Theoretically, the volume flow can also be calculated or approximated using the motor speeds of the booster pump 2, 11 if there is sufficient knowledge of the system.

The feed flow through the inlet to the membrane module 4 can also be used to control the overflow. Either the flow sensor 22 or 7 can be placed in the feed line 3. As the system is closed, the concentrate volume can be calculated from the feed flow minus the permeate volume. Equivalently, the permeate volume can be calculated as the difference between the feed flow and the concentrate volume.

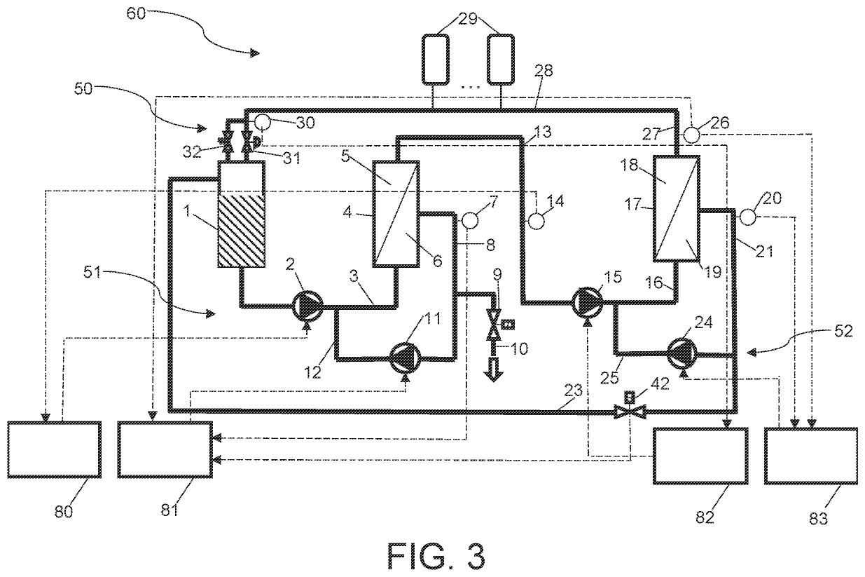

FIG. 3 shows a two-stage membrane filter system 60 in a preferred embodiment, in which the permeate 18 of the second stage is used as feed flow for a third stage or is fed into the ring line 28, which can then be continued accordingly. This configuration can be extended by further stages as required.

The membrane filter system 60 according to FIG. 3 has a first stage 51 and a hydraulically connected stage 52. Similar to a single-stage system, water is drawn from the storage tank 1 via the booster pump 2 and fed into the membrane module 4 with recirculated concentrate 12 as feed flow from the first stage 51 via the feed line 3. The resulting concentrate 6 is partly reused with the aid of the circulation pump 11 of the first stage 51. The non-recirculated part of the concentrate is discharged from the system as waste water 10 via the valve 9. The first control and regulation unit 80 regulates the booster pump 2 of the first stage 51, while the second control and regulation unit 81 regulates the circulation pump 11 of the first stage 51.

The permeate 5 from the first stage 51 is conveyed upstream of the booster pump 15 of the second stage 52. This conveys the permeate 5 from the first stage 51 together with the recirculated concentrate from the second stage 25 as a feed flow through a feed line 16 into the membrane module 17 of the second stage 52. The resulting concentrate 19 is partially reused with the aid of the circulation pump 24 of the second stage 52. The non-recirculated part of the concentrate 19 is channeled into the storage tank 1 via the valve 42 as discard 23. The permeate 18 from the second stage 52 is fed into the ring line 28.

A third control and regulation unit 82 is connected on the signal input side to the pressure sensor 30 and regulates the speed of the booster pump 15 of the second stage 52. A fourth control and regulation unit 83 is connected on the signal input side to the flow sensors 20, 26 of the second stage 52 and regulates the circulation pump 24 of the second stage 52.

A self-regulating flow limiter 31 allows a defined volume (independent of the pressure) to flow back into the storage tank 1. At a defined threshold value, the overflow valve 32 opens and lets water back into the storage tank 1. A connected consumer 29, which takes permeate from the ring line 28, causes a pressure drop in the ring line 28. This pressure drop is detected by a pressure sensor 30 and the control and regulation unit 82 generates a corresponding speed increase at the booster pump 15 of the second stage 52. This speed increase also reduces the permeate pressure of the first stage, as the permeate volume of the second stage 52 must be served by the first stage 51.

The falling inlet pressure of the second stage 52 is registered by a pressure sensor 14 and also leads to a speed adjustment of the booster pump 2 of the first stage 51. The circulation pump 24 of the second stage 52 adjusts the overflow according to the measured permeate volume of the second stage 52 (by the flow sensor 26) and the measured concentrate volume of the second stage 52 (by the flow sensor 20).

The permeate volume flow of the first stage 51 is calculated by the control and regulation unit 81 using the measured permeate volume flow of the second stage 52 and a constant factor. The factor is added as soon as the valve 42 is opened. The factor results from the empirically known value of the volume flow through the valve 42. This variant was selected in order to save a sensor, but the value can nevertheless also be recorded via a sensor. This applies both to the discard 23 of the second stage 52 and to the permeate flow of the permeate 5 of the first stage 51. The individual controllers are independent of each other, but implicitly interconnected and dependent on each other by the system.

The membrane filter system 60 can generate energy savings by reducing the rotational speed during a lower extraction period. There are also secondary effects such as a reduction in overall water consumption and a lower noise level. As the overflow of the respective membrane in the membrane modules 4, 17 is optimized at all times within the manufacturer's specification, a longer service life of the membrane is made possible.

In both FIGS. 2 and 3, an overflow valve 32 is installed at the end of the ring line 28 upstream of the storage tank 1 in order to intercept pressure surges within the ring line 28. In other preferred embodiments, this overflow valve 32 can be installed at any other position within the ring line 28 in order to avoid overpressure.

Within the two arrangements shown in FIGS. 2 and 3, the overflow valve 32 fulfils the secondary function of a bypass, which can be used to convey increased volume through the ring line 28. This is necessary, for example, for chemical and thermal disinfection.

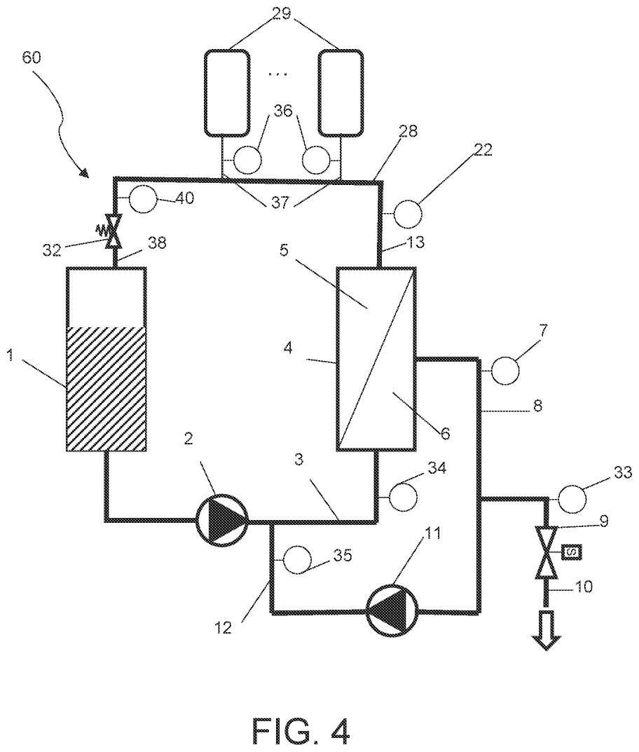

FIG. 4 shows a further preferred embodiment of a membrane filter system 60, which realizes an alternative control concept via the volume flow. The operating sequence and the components are essentially identical to those described so far in FIGS. 2 and 3, with the difference that no flow limiter is arranged at the end of the ring line 28 upstream of the storage tank 1.

An overflow valve 32 is arranged at the end of the ring line 28 at the tank inlet of the storage tank 1, which maintains a defined pressure within the ring line 28 and varies the volume flow. In this case, the process variable for the booster pump 2 is the volume flow at the end of the ring line, which is measured by a flow sensor 40. Alternatively, flow sensors 36 can also be used to detect how much water is being drawn off by the consumers 29 at draw-off points, i.e., between the respective consumer 29 and the ring line 28. In this way, a setpoint adjustment of the booster pump 2 for the permeate volume flow can be generated at the flow sensor 22 of the ring line inlet. The setpoint value then represents the totalized consumption 37 and a predetermined offset volume 38. The at least one control and regulation unit is not shown in this figure.

Equivalent control is also possible with multi-stage systems. In this case, the control and regulation units receive a volume flow as an input variable and must supply the required supply flow of the downstream stage. The setpoint value can either be calculated or measured.

The same control principle can be used for the circulation pump 11 as for the membrane filter systems 60 described above, although the process value can also be formed in other ways. Systematically, the volume flow of feed or ring line 28, permeate 5 and concentrate 6 are connected to each other and can be substituted for each other. This enables a diverse sensor arrangement.

The following three formulae show the general ratio of the volume flows in the membrane filter system 60. It is possible to arrive at an identical result as in single-stage systems (FIG. 2) using other process values. It is also possible to use empirical values (compare with the multi-stage system according to FIG. 3) to replace sensors and also achieve an identical result.

$${V}_{Feed} = {V}_{concentrate} + {V}_{Permeate}$$

$${V}_{concentrate} = {V}_{circulated concentrate} + {V}_{waste water}$$

$${V}_{Permeate} = {V}_{consumption} + {V}_{overflow volume}$$

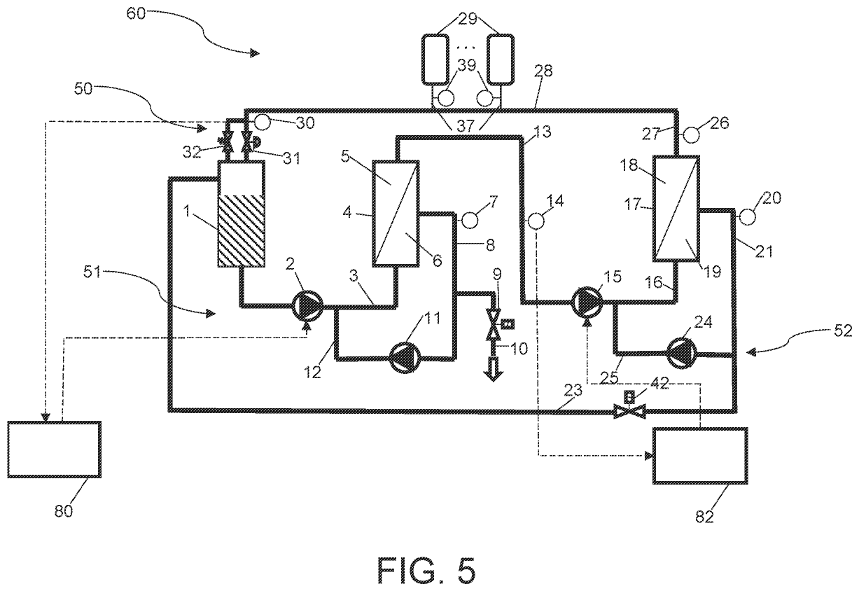

In FIG. 5, a multi-stage membrane filter system 60 is shown in a preferred embodiment with a further preferred variant of a control system. This control system is a modified version of the preferred variant for multi-stage systems. The circulation pumps 11, 24 are also controlled, but according to one of the variants already described and are therefore not explicitly described again.

The booster pump 2 of the first stage 51 uses the pressure sensor 30 at the end of the ring line 28 as a process variable. The booster pump 15 of the second stage 52 utilizes an inverse control principle and uses the pressure sensor 14 in the permeate of the first stage 51. When the permeate is reduced by a consumer 29, the booster pump 2 of the first stage 51 reacts by increasing its speed. This results in a rising permeate pressure in the first stage 51. Due to the inverse control principle, the pressure sensor 14 in the permeate of the first stage generates an increase in the speed of the booster pump 15 of the second stage 52. This leads to an increase in the permeate pressure of the second stage 52. This increase leads to a reduction in the setpoint deviation of the booster pump 2 of the first stage 51.

The system or the membrane filter system 60 is also scalable and not limited to two stages 51, 52 as shown here in the example. FIG. 5 also shows the possibility of using an alternative pressure sensor 39 as a process variable. The pressure sensors 39 are arranged at the pick-up points. The pressure sensor that is furthest away from the feed point of the ring line 28 (the left consumer in the figure) is used as the process variable.

Sensors from connected consumers 29 can be used to implement the concept described here or in FIG. 2 and FIG. 3. The lowest pressure value (at steady state) is used as the process variable, as this device is furthest away from the system. If necessary, the setpoint value must be adjusted in order to compensate for pressure losses and ensure a constant volume flow via the flow limiter 31.

In a preferred embodiment, it is also possible for the membrane filter system 60 shown in FIG. 5 to measure a flow rate setpoint value at the end of the ring line 28 with the aid of a flow sensor 40 (see FIG. 4), whereby all consumers 29 signal their removed volume (measured via the flow sensors 36) to the membrane filter system 60. The sum of all volume flows must then flow via a flow sensor 26. In this case, as shown in FIG. 4, only an overflow valve 32 and no flow limiter 31 is used.

As an alternative to an overflow valve 32 shown in the illustrations of FIGS. 2, 3 and 5, a pressure expansion vessel or an elastic ring line material can also be used to minimize pressure surges. Likewise, an attenuator, e.g., an overflow valve 32, can be connected as a consumer 29 to fulfil the same effect, but without being directly identified as a system component.

The control processes described in connection with the membrane filter systems 60 according to FIGS. 1-5 are preferred process steps of methods for operating the respective system.

1. A membrane filter system comprising:
a storage tank;
a ring line for connecting consumers;
at least one stage comprising:
a membrane module connected to a concentrate line for delivering a concentrate volume flow and a permeate line for delivering a permeate volume flow;
a feed line to the membrane module;
at least one booster pump for pumping liquid into the membrane module; and
at least one circulation pump for returning concentrate from the membrane module to the feed line:
at least two sensors, each sensor configured to measure a process variable; and
at least one control and regulation unit,
each of the at least two sensors being connected on an signal input side to the at least one control and regulation unit, and
the at least one control and regulating unit configured to regulate the at least one booster pump and at least one circulation pump based on sensor signals of the at least two sensors.

2. The membrane filter system according to claim 1, wherein the at least one control and regulation unit is configured to adapt a permeate volume flow and a concentrate volume flow to a current consumer withdrawal by regulating the at least one booster pump and the at least one circulation pump.

3. The membrane filter system according to claim 1, further comprising at least one pressure sensor, wherein the at least one control and regulating unit is configured, when a measured pressure by the pressure sensor increases a speed of the booster pump in such a way that the pressure setpoint value is reached by the actual pressure value, and when the pressure setpoint value is exceeded by the measured pressure, reduces the speed of the booster pump in such a way that the pressure setpoint value is reached by the actual pressure value.

4. The membrane filter system according to claim 3, wherein the pressure sensor is arranged at one end of the ring line.

5. The membrane filter system according to claim 4, further comprising a first flow sensor arranged at a beginning of the ring line for measuring liquid flow leaving the membrane module on a permeate side and a second flow sensor for measuring liquid flow leaving the membrane module on a concentrate side, wherein the at least one control and regulation unit is configured to control a speed of the circulation pump as a function of the flow rate measured by the first and second flow sensors and the formation of the membrane module and the overflow factor such that a desired flow rate setpoint value is realized.

6. The membrane filter system according to claim 1, further comprising an attenuator.

7. The membrane filter system according to claim 6, wherein the attenuator comprises an overflow valve that opens as soon as pressure applied to the overflow valve is greater than a set holding pressure.

8. The membrane filter system according to claim 6, wherein the attenuator comprises an overflow valve and a flow limiter.

9. The membrane filter system according to claim 6, wherein the attenuator is a membrane expansion vessel or a solenoid valve in conjunction with a pressure switch or pressure sensor.

10. The membrane filter system according to claim 1, wherein the membrane module comprises a plurality of sub-membrane modules connected in series or in parallel, wherein each sub-membrane module comprises one or more membranes.

11. The membrane filter system according to claim 1, further comprising an overflow valve and at least one flow sensor arranged in the ring line, which is connected on the signal input side to the control and regulating unit, which regulates the booster pump according to a flow setpoint value.

12. The membrane filter system according to claim 1 wherein the at least one stage consists of one stage.

13. The membrane filter system according to claim 1, wherein the at least one stage comprises a multi-stage system with a first stage and at least one further stage, wherein the at least one further stage is hydraulically connected downstream to the first stage.

14. The membrane filter system according to claim 13, wherein the at least one further stage comprises a second stage,
the first stage comprising a first membrane module, a first booster pump and a first circulation pump,
the second stage, which is arranged downstream of the first membrane module, comprising a second membrane module, a second booster pump downstream of the first membrane module and a second circulation pump,
a first pressure sensor being arranged on a suction side of the second booster pump, the at least one control and regulating unit configured to perform a pressure setpoint control of the first booster pump based on a pressure value measured by the first pressure sensor,
a second pressure sensor being arranged downstream of the second membrane module, and
the at least one control and regulating unit configured to perform a pressure setpoint control of the second booster pump based on a pressure value measured by the second pressure sensor.

15. The membrane filter system according to claim 13, wherein the at least one further stage comprises a second stage,
the first stage comprising a first membrane module, a first booster pump and a first circulation pump,
the second stage being arranged downstream of the first membrane module, comprising a second membrane module, a second booster pump downstream of the first membrane module and a second circulation pump,
a first pressure sensor being arranged at an end in the ring line upstream of the storage tank,
the at least one control and regulation unit configured to perform a pressure setpoint regulation of the first booster pump based on a first pressure value measured by the first pressure sensor,
a second pressure sensor being arranged on a permeate side downstream of the first membrane module, and
the at least one control and regulation unit configured to perform a pressure setpoint regulation of the second booster pump based on a second pressure value measured by the second pressure sensor.

16. A method for membrane filtration of a liquid comprising the steps of:
conveying the liquid by at least one booster pump through a feed line into a first membrane module;
feeding permeate directly or through a second membrane module into a ring line, to which consumers are connectable and/or are connected;
feeding concentrate that leaves at least one of the first membrane module and the second membrane module back into the feed line by at least one circulation pump; and
measuring a process variable with at least two sensors,
wherein at least one booster pump and at least one circulation pump are controlled based on the measured process variable in such a way that a permeate volume flow and a concentrate volume flow are adapted to a current consumer withdrawal.

17. The method according to claim 16, wherein the process variable is the pressure and/or the liquid flow rate at a point of the ring line.
